(19) United States
(12) Patent Application Publication
(10) Pub. No.: US 2024/0185011 A1
(43) Pub. Date: Jun. 6, 2024

(54) System And Method For Retrieving And Storing Digital Tickets

(71) Applicant: Anthony Ferriso, Middle village, NY (US)

(72) Inventor: Anthony Ferriso, Middle village, NY (US)

(21) Appl. No.: 18/061,490

(22) Filed: Dec. 5, 2022

(51) Int. Cl. G06K 7/14; G06K 19/06

(52) U.S. Cl. CPC G06K 7/1417; G06K 19/06037

(57) ABSTRACT

A system and method for retrieving and storing digital tickets is disclosed. The system comprises a user device configured to, using an application for scanning a physical ticket for a vehicle in a parking lot to attain an image of the physical ticket. The system also comprises a computer readable medium associated with the user device and coupled with a processor via network. The processor configured to retrieve ticket information of one or more tickets owned by a user from scanned tickets, transmit the ticket information to a remote storage, generate a request to convert the scanned ticket into a digital ticket, the request including the ticket information, generate the digital ticket based on the image of the physical ticket, store the ticket information of the scanned ticket and converted digital ticket, and allow access to the stored digital ticket for further scan when required.

### TECHNICAL FIELD

The present invention pertains generally to a ticketing system and method thereof. More particularly, embodiments of the present invention provide a system and method for retrieving and storing digital tickets.

### BACKGROUND ART

Car ownership has increased dramatically in recent years, which has inevitably caused the parking crisis. Parking tickets in parking lots appear to be a solution to the problem. Drivers must contend with a scarcity of parking spaces, congestion in garages and parking lots, and lengthy payment procedures. Parking operators struggle to manage parking spaces and keep up with parking tickets.

Paper tickets are commonly used to grant customers access to sporting and general entertainment events. The ticket is a contract that grants the holder the right to attend the event and, in most cases, to sit in a specific seat. The general public is becoming more interested in digital or electronic tickets.

As a result, various industry participants have devised various approaches to enabling flexible and quick ticket usage.

Organizations consider Internet technology to be the most widely used information and communication technology. Internet technology has the potential to simplify transaction processes and strengthen relationships between businesses and their customers.

As a result of the preceding discussion, there is an urgent need for a technical solution that overcomes the limitations. The focus of this disclosure is on a system and method for retrieving and storing digital tickets.

### SUMMARY OF THE DISCLOSURE

The following is a summary description of illustrative embodiments of the invention. It is provided as a preface to assist those skilled in the art to more rapidly assimilate the detailed design discussion which ensues and is not intended in any way to limit the scope of the claims which are appended hereto in order to particularly point out the invention.

According to illustrative embodiments, the present disclosure focuses on a system and method for retrieving and storing digital tickets which partially overcome the above mentioned disadvantages or provide the users with a useful or commercial choice.

An object of the present invention is ease of payment if the ticket is lost without paying any extra charges.

Another object of the present invention is to provide a contactless and digital ticket generation and payment system that is advantageous when the ticket is lost.

The present invention is user-friendly and compatible with any type of parking tickets.

According to the first aspect of the present disclosure, a system for retrieving and storing digital tickets is disclosed. The system comprises a user device configured to, using an application for scanning a physical ticket for a vehicle in a parking lot to attain an image of the physical ticket. The system also comprises a computer readable medium associated with the user device and coupled with a processor via network. The processor configured to retrieve ticket information of one or more tickets owned by a user from scanned tickets. The processor is also configured to transmit the ticket information to a remote storage. The processor is also configured to generate a request to convert the scanned ticket into a digital ticket. Further, the request may include the ticket information. The processor is also configured to generate the digital ticket based on the image of the physical ticket. The processor is also configured to store the ticket information of the scanned ticket and converted digital ticket. The processor is also configured to allow access to the stored digital ticket for further scanning when required.

According to the second aspect of the present disclosure, a method for retrieving and storing digital tickets is disclosed. The method also includes scanning a physical ticket for a vehicle in a parking lot to attain an image of the physical ticket via user device using an application. The method also includes associating a computer readable medium with the user device and a processor via network. The method also includes retrieving ticket information of one or more tickets owned by a user from scanned tickets. The method also includes transmitting the ticket information to a remote storage. The method also includes generating a request to convert the scanned ticket into a digital ticket, the request including the ticket information. The method also includes generating the digital ticket based on the image of the physical ticket. The method also includes storing the ticket information of the scanned ticket and converting digital ticket on the remote storage. The method includes allowing access to the stored digital ticket for further scan when required.

These and other advantages will be apparent from the present application of the embodiments described herein.

The preceding is a simplified summary to provide an understanding of some embodiments of the present invention. This summary is neither an extensive nor exhaustive overview of the present invention and its various embodiments. The summary presents selected concepts of the embodiments of the present invention in a simplified form as an introduction to the more detailed description presented below. As will be appreciated, other embodiments of the present invention are possible utilizing, alone or in combination, one or more of the features set forth above or described in detail below.

### BRIEF DESCRIPTION OF DRAWINGS

To describe the technical solutions in the embodiments of the present disclosure or in the prior art more clearly, the following briefly describes the accompanying drawings required for describing the embodiments or the prior art. Apparently, the accompanying drawings in the following description merely show some embodiments of the present disclosure, and a person of ordinary skill in the art can derive other implementations from these accompanying drawings without creative efforts. All of the embodiments or the implementations shall fall within the protection scope of the present disclosure.

FIG. 1 illustrates a schematic representation of a system and method for retrieving and storing digital tickets, according to embodiments of the present invention.

FIG. 2 illustrates a flowchart of a method for retrieving and storing digital tickets, according to embodiments of the present invention disclosed herein.

The system and method for retrieving and storing digital tickets is illustrated in the accompanying drawings, which like reference letters indicate corresponding parts in the various figures. It should be noted that the accompanying figure is intended to present illustrations of exemplary embodiments of the present disclosure. This figure is not intended to limit the scope of the present disclosure. It should also be noted that the accompanying figure is not necessarily drawn to scale.

### DESCRIPTION OF EMBODIMENTS

Those skilled in the art will be aware that the present disclosure is subject to variations and modifications other than those specifically described. It is to be understood that the present disclosure includes all such variations and modifications. The disclosure also includes all such steps, features, compositions and compounds referred to or indicated in this specification, individually or collectively, and any and all combinations of any or more of such steps or features.

For convenience, before further description of the present disclosure, certain terms employed in the specification, and examples are collected here. These definitions should be read in the light of the remainder of the disclosure and understood as by a person of skill in the art. The terms used herein have the meanings recognized and known to those of skill in the art, however, for convenience and completeness, particular terms and their meanings are set forth below.

The articles “a”, “an” and “the” are used to refer to one or to more than one (i.e., to at least one) of the grammatical object of the article.

The terms “comprise” and “comprising” are used in the inclusive, open sense, meaning that additional elements may be included. It is not intended to be construed as “consists of only”. Throughout this specification, unless the context requires otherwise the word “comprise”, and variations such as “comprises” and “comprising”, will be understood to imply the inclusion of a stated element or step or group of element or steps but not the exclusion of any other element or step or group of element or steps.

The term “including” is used to mean “including but not limited to”, “Including” and “including but not limited to” are used interchangeably.

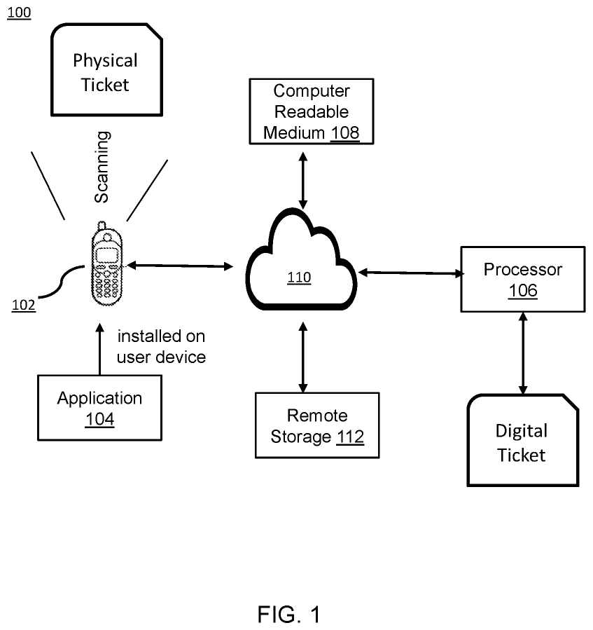

FIG. 1 illustrates a schematic representation of a system and method for retrieving and storing digital tickets, according to embodiments of the present invention. The system 100 comprises a user device 102, an application 104, a processor 106, a computer readable medium 108, a network 110, a remote storage 112, and so forth.

According to the embodiment of the present invention, the user device 102 may be configured to, using the application 104 for scanning a physical ticket for a vehicle in a parking lot to attain an image of the physical ticket. The user device 102 may comprise a smart phone, a computer, such as the desktop computer, a laptop computer or a tablet.

In one example of the present invention, a user may park a car in a parking lot, press a button, and a ticket generating device prints a ticket. The printed ticket can be scanned with a cell phone, and the ticket is saved on the phone; if the user loses the ticket, the user does not have to pay the late fees because the user has proof that the ticket is on the phone.

The computer readable medium 104 may be associated with the user device 102 and coupled with the processor 106 via the network 110. The computer readable medium 108 may be a RAM, a non-volatile storage drive, or any tangible computer-readable media, according to embodiments of the prior invention.

According to embodiments of the present invention, the computer readable medium 108 can be set up to store data such as computer-program product embodiments of the present invention, such as executable computer code, human-readable code, or the like. Floppy discs, removable hard discs, optical storage media such as CD-ROMs, DVDs, bar codes, semiconductor memories such as flash memories, read-only memories (ROMs), battery-backed volatile memories, networked storage devices, and the like are examples of tangible computer-readable media. RAM and non-volatile storage drives can be set up to store the basic programming and data constructs that enable the functionality of the various embodiments of the present invention described above.

The network 110, according to the embodiments of the present invention, may be the Internet, a wide area network (WAN), a local area network (LAN), or another backbone.

The processor 106 may be configured to retrieve ticket information of one or more tickets owned by a user from scanned tickets.

In an embodiment of the present invention, the processor 106 may include at least one computer program that contains programmed instructions, which are used to create at least one computing machine to carry out the method described in one aspect of the invention.

The processor 106 may also be configured to transmit the ticket information to the remote storage 112. The processor 106 may also be configured to generate a request to convert the scanned ticket into a digital ticket. Further, the request may include the ticket information. According to embodiments of the present invention, the ticket information comprises a machine readable code encoding the ticket information. Further, the machine readable code is a quick response (QR) code.

Any encoded image readable by a communication device or any other computing device can be considered “machine readable code.” The machine readable code can be read by a device by scanning it with a camera device that is part of or attached to the device, for example. Quick response codes and SnapTag are two examples of machine readable code.

According to embodiment of the present invention, the machine readable code comprises at least one of a transaction amount, a random number, a ticket issue time, and so forth.

In an embodiment of the present invention, the ticket information may comprise financial credentials data scanned via an application and executed on a ticket reading device.

The processor 106 may be further configured to generate the digital ticket based on the image of the physical ticket. The processor 106 may be configured to store the ticket information of the scanned ticket and converted digital ticket. The processor 106 may be configured to allow access to the stored digital ticket for further scan when required.

Furthermore, in another exemplary embodiment of the present invention, when the user pulls the car into any parking lot and scans the ticket with the QR code, the ticket goes on the user's phone and the digital ticket is stored on the cell phone, and when the user leaves the parking, the ticket may be scanned on the phone again, which may also show the date and time, so there are no late fees if the user lost the printed ticket.

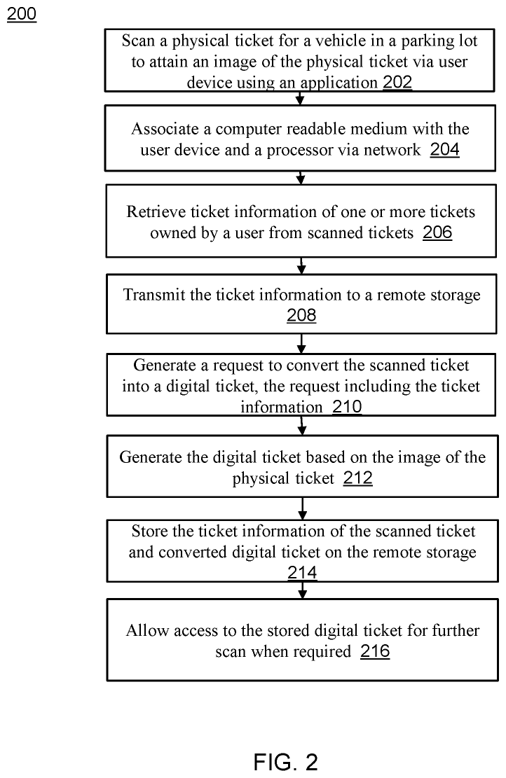

FIG. 2 illustrates a flowchart of a method 200 for retrieving and storing digital tickets, according to embodiments of the present invention.

At 202, scanning a physical ticket for a vehicle in a parking lot to attain an image of the physical ticket via the user device 102 using the application 104.

At 204, associating the computer readable medium 108 with the user device 102 and the processor 106 via the network 110.

At 206, retrieving ticket information of one or more tickets owned by a user from scanned tickets. According to embodiments of the present invention, the ticket information comprises a machine readable code encoding the ticket information. Further, the machine readable code is a quick response (QR) code.

At 208, transmitting the ticket information to the remote storage 112.

At 210, generating a request to convert the scanned ticket into a digital ticket, the request including the ticket information.

At 212, generating the digital ticket based on the image of the physical ticket.

At 214, storing the ticket information of the scanned ticket and converted digital ticket on the remote storage 112.

At 216, allowing access to the stored digital ticket for further scan when required.

In one embodiment of the present invention, the method 200 further comprising obtaining the financial credentials from the application comprises communicating data encoded within the machine readable code to the application and obtaining the financial credentials from a secure element within the user device 102.

While the invention has been described in connection with what is presently considered to be the most practical and various embodiments, it will be understood that the invention is not to be limited to the disclosed embodiments, but on the contrary, is intended to cover various modifications and equivalent arrangements included within the scope of the appended claims.

A person of ordinary skill in the art may be aware that, in combination with the examples described in the embodiments disclosed in this specification, units and algorithm steps may be implemented by electronic hardware, computer software, or a combination thereof.

The foregoing descriptions of specific embodiments of the present technology have been presented for the purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical software, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the software or implementation without departing from the spirit or scope of the claims of the present technology.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

In a case that no conflict occurs, the embodiments in the present disclosure and the features in the embodiments may be mutually combined. The foregoing descriptions are merely specific implementations of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall to the be subject protection scope of the claims.

What is claimed is:

1. A system for retrieving and storing digital tickets, the system comprising:
a user device including an application for scanning a physical ticket for a vehicle in a parking lot to obtain an image of the physical ticket;
a computer readable medium associated with the user device and coupled with a processor via network, the processor configured to:
retrieve ticket information of one or more tickets owned by a user from scanned tickets;
transmit the ticket information to a remote storage;
generate a request to convert the scanned ticket into a digital ticket, the request including the ticket information;
generate the digital ticket based on the image of the physical ticket;
store the ticket information of the scanned ticket and converted digital ticket; and
allow access to the stored digital ticket for further scan when required.

2. The system of claim 1, wherein the ticket information comprises a machine readable code encoding the ticket information.

3. The system of claim 2, wherein the machine readable code is a quick response (QR) code.

4. The system of claim 2, wherein the machine readable code comprises at least one of a transaction amount, a random number, a ticket issue time, or any foregoing combination.

5. The system of claim 1, wherein the ticket information comprises financial credentials data scanned via an application and executed on a ticket reading device.

6. A method for retrieving and storing digital tickets, the method comprising:
scanning a physical ticket for a vehicle in a parking lot to attain an image of the physical ticket via user device using an application;
associating a computer readable medium with the user device and a processor via network;
retrieving ticket information of one or more tickets owned by a user from scanned tickets;
transmitting the ticket information to a remote storage;
generating a request to convert the scanned ticket into a digital ticket, the request including the ticket information;
generating the digital ticket based on the image of the physical ticket;
storing the ticket information of the scanned ticket and converted digital ticket on the remote storage;
allowing access to the stored digital ticket for further scan when required.

7. The method of claim 6, further comprising obtaining the financial credentials from the application comprises communicating data encoded within a machine readable code to the application and obtaining the financial credentials from a secure element within the user device.

8. The method of claim 6, wherein the ticket information comprises a machine readable code encoding the ticket information.

9. The method of claim 8, wherein the machine readable code is a quick response (QR) code.

10. The method of claim 8, wherein the machine readable code comprises at least one of a transaction amount, a random number, a ticket issue time, or any foregoing combination.

11. The method of claim 6, wherein the ticket information comprises financial credentials data scanned via an application and executed on a ticket reading device.
